(19) United States
(12) Patent Application Publication
(10) Pub. No.: US 2015/0299470 A1
(43) Pub. Date: Oct. 22, 2015

(54) SCRATCH AND FINGERPRINT RESISTANT ANTI-REFLECTIVE FILMS FOR USE ON DISPLAY WINDOWS OF ELECTRONIC DEVICES AND OTHER RELATED TECHNOLOGY

(71) Applicant: General Plasma, Inc., Tucson, AZ (US)

(72) Inventors: Phong Ngo, Tucson, AZ (US); John Madocks, Tucson, AZ (US)

(21) Appl. No.: 14/699,963

(22) Filed: Apr. 29, 2015

Related U.S. Application Data
(63) Continuation of application No. PCT/US2015/012785, filed on Jan. 23, 2015.
(60) Provisional application No. 61/931,327, filed on Jan. 24, 2014.
(60) Provisional application No. 62/001,269, filed on May 21, 2014.
(60) Provisional application No. 61/986,247, filed on Apr. 30, 2014.
(60) Provisional application No. 61/987,889, filed on May 2, 2014.

(51) Int. Cl. C09D 5/00; G06F 1/16; G06F 3/041

(52) U.S. Cl. CPC C09D 5/006; G06F 3/0412; G06F 1/1643; G06F 2203/04107

(57) ABSTRACT

A scratch-resistant anti-reflective film in accordance with a particular embodiment includes an anti-reflective stack and a protective layer overlying the anti-reflective stack. The anti-reflective stack has at least six stack layers of alternating higher and lower refractive indexes. The protective layer is at least primarily composed of diamond-like carbon and has a thickness of not more than 5 nm. At least a 15 cm² region of the film is continuous and has an average nanoindentation hardness of at least 8 GPa using the Continuous Stiffness Measurement Technique. An average reflectance off the film at the region from normal incident light of wavelengths from 425 nm to 675 nm is not more than 1%. Average a* and b* in CIELAB color space for reflectance off the film at the region from −45° to 45° incident visible light are within a range from −2.0 to 2.0.

### CROSS-REFERENCE TO RELATED APPLICATION INCORPORATED BY REFERENCE

This application is a continuation of International Application No. PCT/US2015/012785, filed Jan. 23, 2015, entitled “SCRATCH AND FINGERPRINT RESISTANT ANTI-REFLECTIVE FILMS FOR USE ON DISPLAY WINDOWS OF ELECTRONIC DEVICES AND OTHER RELATED TECHNOLOGY,” which claims the benefit of U.S. Provisional Application No. 61/931,327, filed Jan. 24, 2014, entitled “MULTIPLE LAYER NITRIDE AND OXIDE ANTI-REFLECTIVE SCRATCH RESISTANT COATING HAVING A DIAMOND-LIKE CARBON TOP COAT AND USE THEREOF FOR TOUCHSCREEN DEVICES,” U.S. Provisional Application No. 62/001,269, filed May 21, 2014, entitled “LARGE AREA MULTIPLE LAYER NITRIDE AND OXIDE ANTI-REFLECTIVE SCRATCH RESISTANT COATING HAVING A DIAMOND-LIKE CARBON TOP COAT,” U.S. Provisional Application No. 61/986,247, filed Apr. 30, 2014, entitled “MULTIPLE LAYER NITRIDE AND OXIDE ANTI-REFLECTIVE COATING HAVING A SCRATCH RESISTANT, HYDROPHOBIC DIAMOND-LIKE CARBON TOP COAT,” and U.S. Provisional Application No. 61/987,889, filed May 2, 2014, entitled “MULTIPLE LAYER ANTI-REFLECTIVE COATING HAVING A SCRATCH RESISTANT, HYDROPHOBIC DIAMOND-LIKE CARBON TOP COAT.” All of the foregoing applications are incorporated herein by reference in their entireties. To the extent the foregoing applications or any other material incorporated herein by reference conflicts with the present disclosure, the preset disclosure controls.

### TECHNICAL FIELD

The present technology is generally related to, among other things, coatings and other films that enhance the performance of display windows of electronic devices.

### BACKGROUND

Reducing the tendency of substrates to reflect incident light is useful in numerous fields. For example, reducing this tendency can improve the performance of solar cells, camera lenses, eyeglass lenses, building windows, and many other products. Reflection occurs when light transitions from passing though one medium (e.g., air) to passing through an adjacent medium (e.g., a substrate). Reflection is greater when a difference in respective refractive indexes of the mediums is greater and smaller when this difference is smaller. Air has a refractive index of about one, while silicate glass and other solid materials that are substantially transparent at wavelengths in the visible spectrum, have refractive indexes significantly greater than one. One way to reduce the tendency of a substrate to reflect incident light is to coat the substrate with alternating layers of high-refractive-index and low-refractive-index materials. These layers cause destructive optical interference that lessens the intensity of reflected light.

Currently, anti-reflective coatings that include alternating layers of high-refractive-index and low-refractive-index materials are widely used on substrates that transmit ambient light, such as camera lenses, eyeglass lenses, and museum glass. This type of anti-reflective coating, however, is not used (or at least is rarely used) on substrates that transmit light from artificial sources. Examples of substrates that transmit light from artificial sources include windows that overlie display circuitry of electronic devices, such as mobile phones, tablet computers, laptop computers, and televisions. As in other cases, reducing the tendency of these substrates to reflect incident light is potentially advantageous. The current lack of anti-reflective coatings in the field of displays for electronic devices may be due to a conventional perception that anti-reflective coatings are not compatible with the performance requirements of these displays. While this may be true with respect to conventional anti-reflective coatings, the inventors have discovered anti-reflective coatings that are surprisingly well suited for use in this field.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology. For ease of reference, throughout this disclosure identical reference numbers may be used to identify identical or at least generally similar or analogous components or features.

FIG. 1 is a cross-sectional view schematically illustrating a coated substrate in accordance with an embodiment of the present technology.

FIGS. 2A and 2B are an exploded side view and a plan view, respectively, of an electronic device including a coated substrate in accordance with an embodiment of the present technology.

FIG. 3 is a flow chart illustrating a method for making a coated substrate in accordance with an embodiment of the present technology.

FIG. 4 is a graph of reflectance at different wavelengths for a coated substrate in accordance with an embodiment of the present technology.

FIG. 5 is a photograph illustrating the results of a hydrophobicity test performed on a coated substrate not having a diamond-like carbon protective layer (left) and a coated substrate having a diamond-like carbon protective layer (right).

### DETAILED DESCRIPTION

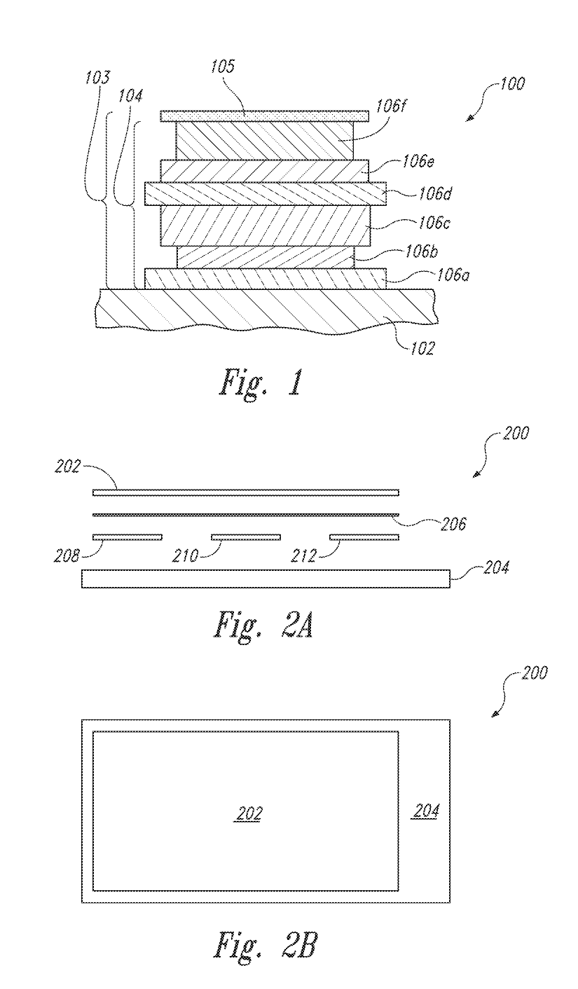

The inventors have discovered, among other things, that films having diamond-like carbon protective layers over anti-reflective stacks made of one or more materials that are harder than the materials typically used in conventional anti-reflective stacks are surprisingly well suited for use with displays of electronic devices. In addition to being anti-reflective, such films are hydrophobic, which can reduce the tendency of electronic-device displays to accumulate fingerprints and other types of smudges during use. Furthermore, the inventors have discovered that high-quality films of this type can be produced rapidly and economically using chemical deposition techniques, such as plasma-enhanced chemical vapor deposition (“PECVD”). Specific details of these and other aspects of the present technology are disclosed herein with reference to FIGS. 1-5. Although the structures and methods may be disclosed herein primarily or entirely with respect to applications in the field of displays for electronic devices, other applications in addition to those disclosed herein are within the scope of the present technology. Furthermore, it should understood, in general, that other structures and methods in addition to those disclosed herein are within the scope of the present technology. For example, structures and methods in accordance with embodiments of the present technology can have different and/or additional configurations, components, and procedures than those disclosed herein. Moreover, a person of ordinary skill in the art will understand that structures and methods in accordance with embodiments of the present technology can be without one or more of the configurations, components, and procedures disclosed herein without deviating from the present technology.

FIG. 1 is a cross-sectional view schematically illustrating a coated substrate 100 in accordance with an embodiment of the present technology. The coated substrate 100 can include a base substrate 102 and a film 103 disposed along a major surface of the base substrate 102. The film 103 can include an anti-reflective stack 104 overlying the base substrate 102 and a protective layer 105 overlying the anti-reflective stack 104. The base substrate 102 can be substantially transparent to light at wavelengths within the visible spectrum. Furthermore, the base substrate 102 can be sized for use with a display of an electronic device (not shown in FIG. 1). For example, the base substrate 102 can have at least one dimension larger than 10 cm (e.g., larger than 30 cm) and/or can have an area within a range from 15 cm² to 300 cm². Although often made of rigid materials, such as silicate glass or sapphire, the base substrate 102 can alternatively be made of relatively flexible materials, such as certain polymeric materials.

The anti-reflective stack 104 can include multiple stack layers in overlying contact. In the illustrated embodiment, the anti-reflective stack 104 includes six stack layers 106 (individually identified as stack layers 106a-106f) with a first stack layer 106a directly overlying the base substrate 102, a second stack layer 106b directly overlying the first stack layer 106a, a third stack layer 106c directly overlying the second stack layer 106b, etc. In other embodiments, the anti-reflective stack 104 can include more than six stack layers. As described in International Application No. PCT/US2014/068966, which is incorporated herein by reference in its entirety, anti-reflective stacks having at least six stack layers can have superior reflectivity performance relative to anti-reflective stacks having fewer than six stack layers. This superior reflectivity performance can be concentrated at wavelengths near the low and high ends of the visible spectrum. Performance at these wavelengths tends to be of greater importance in the context of electronic displays than in other applications (e.g., solar panels and building windows).

The stack layers 106 can have different compositions and can be arranged so that neighboring stack layers 106 have different refractive indexes. For example, the stack layers 106 can be successively stacked with alternating higher and lower refractive indexes. The first, third, and fifth stack layers 106a, 106c, 106e can be high-refractive-index stack layers and the second, fourth, and sixth stack layers 106b, 106d, 106f can be low-refractive-index stack layers. In at least some embodiments, at least one (e.g., all three) of the low-refractive-index stack layers has a refractive index within a range from 1.40 to 1.52 at a wavelength of 632 nm. In these and/or other embodiments, at least one (e.g., all three) of the high-refractive-index stack layers can have a refractive index within a range from 1.66 to 2.39 at a wavelength of 632 nm.

Conventional anti-reflective films disposed on substrates are often relatively soft and susceptible to scratching. This can be problematic, especially in the context of electronic devices that are frequently handled, such as electronic devices that are mobile and/or have touch-operated displays. When a conventional anti-reflective film is scratched, the ability of the film to suppress reflection from a corresponding substrate at the location of the scratch is compromised. The film, however, continues to suppress reflection from the substrate at locations around the scratch. The resulting difference in reflectance undesirably highlights the appearance of the scratch. There is a need, therefore, for anti-reflective films that are scratch resistant. The same is true for films that impart other beneficial properties to transparent substrates. Hydrophobicity, which increases the tendency of substrate to accumulate fingerprints and other types of smudges, is one such property. Conventional approaches to imparting hydrophobicity to substrates have included the use of fluoro-alkyl silane and other coating materials that tend to have poor durability.

Films and coated substrates in accordance with embodiments of the present technology can at least partially address the problems described above and/or other problems associated with conventional technology in this field. For example, in at least some embodiments, a protective layer at least primarily composed of diamond-like carbon (e.g., amorphous carbon with a sp³/sp² bond ratio of greater than 50%) increases the scratch resistance and hydrophobicity of an anti-reflective stack. Diamond-like carbon is a durable, low-friction, hydrophobic, and chemically-inert material that resists wear, smudging, fingerprints, and chemical degradation. These attributes are all useful in the context of electronic-device displays.

Unfortunately, diamond-like carbon also has certain undesirable optical properties that may have made it conventionally appear to be unacceptable for use in the context of electronic-device displays. For example, diamond-like carbon is characterized by relatively high absorption in the visible spectrum. This can give diamond-like carbon a yellow or brown color. Such absorption is not problematic in most applications for anti-reflective coatings. For example, in architectural glass and car windshields, some absorption can be desirable as tinting. In the context of electronic-device displays, however, high absorption in a display window can make an electronic display transmitted to a user via the window undesirably appear dimmer and less sharp than it would otherwise appear. A white background shown in an electronic display, for example, may appear yellow. This effect on image quality is not acceptable. The inventors have found, however, that the undesirable optical properties of diamond-like carbon may have only a negligible effect on the optical performance of an anti-reflective film when the diamond-carbon is very thin. With reference to FIG. 1, the thickness of the protective layer 105 can be, for example, not more than 5 nm (e.g., within a range from 1 to 5 nm), not more than 4 nm (e.g., within a range from 1 to 4 nm), or not more than 3 nm (e.g., within a range from 1 to 3 nm). In a particular embodiment, the thickness of the protective layer 105 is 2 nm. In at least some embodiments, photopic absorption by the film 103 is less than 1% over the visible spectrum.

The inventors have also found that use of relatively hard materials (e.g., Si₃N₄) in the high-refractive-index stack layers of the anti-reflective stack 104 may facilitate the use of a very thin protective layer 105. By way of theory, and without wishing to be bound to a particular theory, when the anti-reflective stack 104 is relatively hard, it may be better able to mechanically support the protective layer 105 than when the anti-reflective stack 104 is softer. When adequately supported, even when the protective layer 105 is very thin, it can be surprisingly effective for imparting hydrophobicity and additional scratch resistance to the anti-reflective stack 104. Suitable materials for one, some, or all of the high-refractive-index stack layers of the anti-reflective stack 104 include, for example, transparent nitrides, such as silicon nitride (Si₃N₄), aluminum nitride (AlN), silicon oxynitirde (SiOₓN_{y}), and aluminum oxynitride (AlON). Suitable materials for one, some, or all of the low-refractive-index stack layers of the anti-reflective stack 104 include, for example, transparent oxides, such as silicon dioxide (SiO₂). The film 103 can have an average nanoindentation hardness of at least 8 GPa using the Continuous Stiffness Measurement Technique. In at least some cases, the film 103 has an average nanoindentation hardness of at least 9 GPa using the Continuous Stiffness Measurement Technique, which is greater than the hardness of most types of glass currently used in electronic-device displays.

Although the use of an anti-reflective film can significantly reduce reflection from a substrate, some reflection typically occurs even when an anti-reflective film is present. Unlike many other applications for anti-reflective films, electronic-device displays tend to be highly sensitive to color distortions in this residual reflection, such as rainbow-like color distortions associated with non-uniformity of the optical thickness in the anti-reflective stack. For example, when an electronic display is off, it usually appears black, which tends to highlight reflectance color distortion that might not otherwise be visible. The severity of reflectance color distortion is directly proportional to the degree to which the thickness of an anti-reflective film is non-uniform. Uniform thickness in an anti-reflective film has conventionally been difficult to achieve. Instead, the color of conventional anti-reflective films is often shifted to mask reflectance color distortion when a high level of reflectance color distortion is undesirable. This masking, however, is not possible in the context of electronic-device displays. As discussed above, in this context, it is typically important for a display not to be dimmed. Furthermore, it is typically important for all colors that are transmitted through a display window to be transmitted with fidelity. Otherwise, the capacity of an electronic device to render image content in an aesthetically acceptable manner would be compromised. Still further, due a particularity of the human photopic response, a color shift over a relatively small region tends to be more noticeable than the same shift over a relatively large region. Thus, color shifting may be especially undesirable in the context of displays of mobile phones and other relatively small electronic devices.

Use of Si₃N₄ in an anti-reflective stack, due to the low dispersion of Si₃N₄ relative to at least some conventional counterpart materials (e.g., TiO₂), can mitigate the severity of reflectance color distortion. For example, thickness non-uniformities in a film that includes an anti-reflective stack having Si₃N₄ high-refractive-index stack layers are expected to cause less reflectance color distortion than the same thickness non-uniformities in a film that includes an anti-reflective stack having TiO₂ high-refractive-index stack layers. Therefore, incorporating Si₃N₄ into high-refractive-index stack layers of an anti-reflective stack can be advantageous both for facilitating the use of a thin protective layer 105 and thereby addressing the problem of scratching and fingerprint accumulation and for decreasing the problem of reflectance color distortion. These problems are of particular importance in the context of electronic-device displays.

Si₃N₄ has an apparent limitation of having a lower refractive index than at least some conventional counterpart materials used in high-refractive-index stack layers of anti-reflective stacks. As a result, an anti-reflective stack with Si₃N₄ high-refractive-index stack layers and only four total stack layers is not expected to be capable of adequately suppressing reflection near the low and high ends of the visible spectrum. Furthermore, four-layer anti-reflective stacks in general (even when such stacks include relatively high-refractive-index materials) tend to exhibit unacceptable reflectance color distortion at off-normal incident viewing angles. These limitations are unacceptable in most electronic-device displays. The inventors have found, however, that increasing the total number of stack layers in an anti-reflective stack to be at least six can address certain limitations of four-layer anti-reflective stacks. Conventionally, forming six-layer anti-reflective stacks with adequate thickness uniformity to suppress reflectance color distortion in electronic-device displays has not been feasible. Furthermore, the significance of forming six-layer anti-reflective stacks instead of four-layer anti-reflective stacks has not been recognized. The net advantage of increasing the number of layers in an anti-reflective stack for an electrical-device display may tend to diminish as the number of layers increases above six. Accordingly, anti-reflective stacks within films in accordance with some embodiments of the present technology include (a) exactly six stack layers, or (b) at least six, but not more than eight stack layers. Anti-reflective stacks within films in accordance with other embodiments of the present technology can include more than eight stack layers.

Rather than being sputtered, the stack layers 106 can be chemically deposited. For example, the stack layers 106 can be deposited by a chemical reaction that occurs within a reaction chamber of a plasma enhanced chemical vapor deposition (PECVD) apparatus. Chemical deposition (e.g., PECVD) can produce six-layer anti-reflective stacks with adequate thickness uniformity to suppress reflectance color distortion. The film 103 can have a continuous region of at least 15 cm², such as at least 25 cm² or at least 35 cm². Over a maximum dimension of this region, the film 103 can have an optical thickness variation of not more than 3%, such as not more than 2%, not more than 1.5%, or not more than 1%. In at least some embodiments, average a* and b* in CIELAB color space for reflectance off the film 103 from normal incident light of wavelengths from 425 nm to 675 nm are expected to be within a range from −1.5 to 1.5, a range from −1.0 to 1.0, or another range compatible with electronic-device display applications. Furthermore, average a* and b* in CIELAB color space for reflectance off the film 103 from 45° to 45° incident light of wavelengths from 425 nm to 675 nm are expected to be within a range from −2.0 to 2.0. Reflectance color at off-normal incident angles can be more important in the context of electronic-device displays than in other contexts. The inventors have discovered that a six-layer anti-reflective stack may achieve suitable reflectance color neutrality at off-normal incident angles more readily than a corresponding four-layer anti-reflective stack.

FIGS. 2A and 2B are an exploded side view and a plan view, respectively, of an electronic device 200 including a coated substrate 202 in accordance with an embodiment of the present technology. In the illustrated embodiment, the device 200 is a mobile phone. In other embodiments, the device 200 can be a tablet computer, a laptop computer, a television, etc. Furthermore, although the illustrated coated substrate 202 is rectilinear with square corners, in other embodiments, the coated substrate 202 can have one or more rounded corners, be non-planar (e.g., curved), and/or have other suitable forms. The device 200 can further include a housing 204 and various electronic components disposed within the housing, such as display circuitry 206, a processor 208, memory 210, and a power source 212. The display circuitry 206 can be operable to generate an electronic display, such as a touch-operated display. The coated substrate 202 can be attached to the housing 204 and can overlie the display circuitry 206 such that the electronic display is viewable via the coated substrate 202. Other configurations of electronic devices including coated substrates in accordance with embodiments of the present technology are also possible.

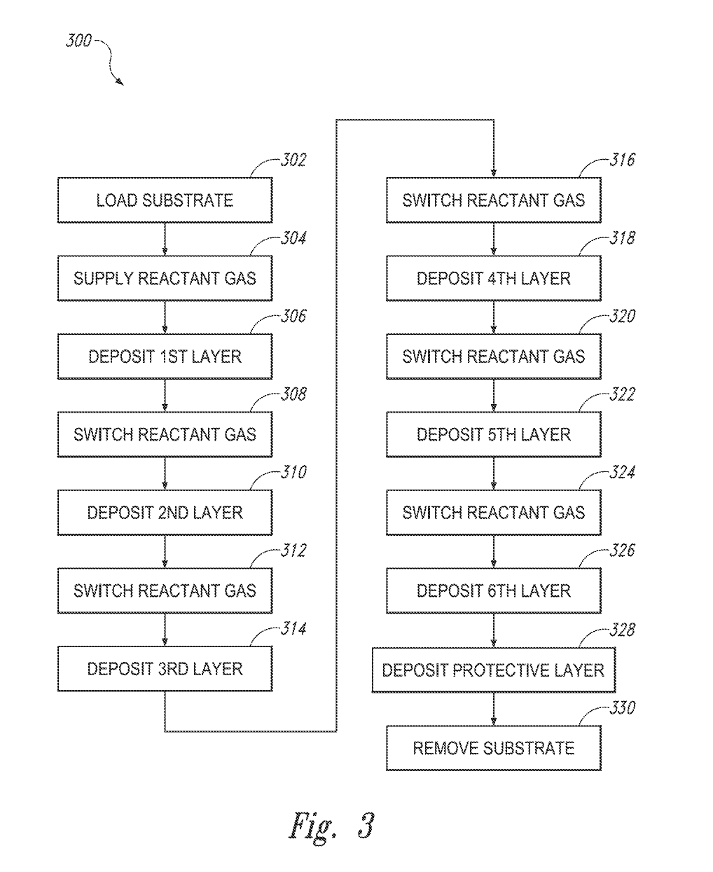

FIG. 3 is a flow chart illustrating a method 300 for making a coated substrate in accordance with an embodiment of the present technology. The method 300 can include loading or otherwise introducing a substrate into a PECVD apparatus (block 302). Suitable PECVD apparatuses are described, for example, in International Publication No. WO 2010/077659, which is incorporated herein by reference in its entirety. The PECVD apparatus can be configured to generate a steady-state supply of ions that are directed into a reaction chamber through which the substrate is conveyed (e.g., linearly). In at least some cases, the PECVD apparatus includes two electrodes operated in concert, each functioning alternatingly as a sputtering magnetron and a closed-drift ion source. The reaction chamber can be reduced to a vacuum pressure (e.g., not more than about 0.05 Pa) and the method 300 can further include supplying suitable reactants for forming a first stack layer on the substrate (block 304). In one example, the reactants are silane and ammonia to form Si₃N₄. A suitable flow rate for ammonia, for example, can be within a range of 500 to 3000 sccm per meter of substrate width. A suitable flow rate of silane, for example, can be 50-100% of the flowrate of the ammonia. A suitable power density for generating the steady-state supply of ions can be, for example, within a range of 5 kW to 30 kW per meter of substrate width. With the supplied gasses, the pressure within the reaction chamber can be within a range of 0.2 Pa to 2 Pa.

In the presence of the steady-state supply of ions and the reactants, the first stack layer can be chemically deposited onto the substrate (block 306). For example, the substrate can be moved through the reactor chamber at a constant rate. If precursor flow rates and power supply settings are constant, the rate at which the substrate travels through the reaction chamber can be used to dictate the thickness of the chemically deposited stack layer. In at least some cases, use of an AC ion source allows settings for each layer of an anti-reflective stack to be determined empirically by measuring each layer and then be applied as a repeatable recipe. This can allow the layers of the anti-reflective stack to be deposited successively without breaking the vacuum within the reaction chamber between each deposition, which may facilitate depositing stack layers of highly uniform thickness.

After the first stack layer is formed, the reactants can be switched (block 308). For example, the reactants can be switched to silane and oxygen to form SiO₂ (block 308). Next, the method 300 can include depositing the second stack layer in the presence of the steady-state supply of ions and the new reactants. This can be repeated (blocks 312-326) until six stack layers have been deposited. The method 300 can then include depositing a protective layer (block 328). In the illustrated embodiment, diamond-like carbon is chemically deposited using the PECVD apparatus to form the protective layer 105. In other embodiments, diamond-like carbon can be chemically deposited in a different apparatus or physically deposited, such as by sputtering. After the protective layer 105 has been deposited, the method 300 can include removing the substrate from the PECVD apparatus (block 328). In some cases, the substrate is coated on both sides. In other cases, the substrate is coated on only one side. For example, some electronic-device display covers include an index-matching adhesive on their inside surfaces. This may eliminate the need for anti-reflective films to be disposed on these inside surfaces.

Use of PECVD in the method 300 can facilitate achieving a level of thickness uniformity in an anti-reflective stack that previously was not practically achievable. For example, ion beam assisted deposition as an alternative to PECVD tends to be too slow to satisfy the production requirements typical of electronic-device displays. As another example, sputtering as an alternative to PECVD tends to be too imprecise to satisfy the performance requirements typical of electronic-device displays. As discussed above, achieving a high level of thickness uniformity by PECVD can allow for the use of six-layer anti-reflective stacks without undue reflectance color variation. This, in turn, can allow for the advantageous use of Si₃N₄ high-refractive-index stack layers and a diamond-like carbon protective layer. Six-layer anti-reflective stacks without undue reflectance color variation can also allow for the use of materials other than Si₃N₄ that are desirable for their mechanical properties (e.g., hardness), but have relatively low refractive indexes.

Nb₂O₅ and TiO₂ are the most common materials used in high-refractive-index layers of conventional anti-reflective stacks. Nb₂O₅has a relativity high refractive index, relatively low dispersion, and a relatively high sputter rate. Nb₂O₅, however, has a nanoindentation hardness of just 2.2 GPa, so it tends to be too soft for use in anti-reflective stacks on electronic-device displays. TiO₂ is somewhat harder than Nb₂O₅, but has relatively high dispersion, which makes repeatably obtaining a neutral color difficult. Also, sputtering TiO₂ tends to be very slow. Si₃N₄ is much harder than both TiO₂ and Nb₂O₅, but manufacturing challenges associated with forming Si₃N₄ and the relatively low refractive index of Si₃N₄, as discussed above, have previously made Si₃N₄ an impractical option for widespread use in anti-reflective stacks. Like TiO₂, Si₃N₄ sputters slowly. In addition, silicon getters oxygen readily, so O₂ or H₂O contamination in a vacuum system can cause preferential formation of SiOₓN_{y}, which has an even lower refractive index than Si₃N₄. Furthermore, typical deposited Si₃N₄ exhibits a pronounced absorption edge at lower visible wavelengths. Achieving sufficient environmental stability is another common technical challenge associated with use of Si₃N₄ in anti-reflective stacks.

Coated substrates in accordance with some embodiments of the present technology are larger than the size of substrates typically used with electronic-device displays. Large substrates, for example, can have at least one dimension greater than 10 cm. Examples of large substrates include automotive windshields and building windows that can exceed 3 meters in width. Small coated substrates in accordance with some embodiments of the present technology other than coated substrates used with electronic-device displays include, for example, timepiece faceplates and camera lenses. Furthermore, coated substrates in accordance with at least some embodiments of the present technology can be flat like window glass or curved like an automotive windshield.

PECVD coating chambers can be configured to accommodate different substrate sizes and production quantity requirements. For example, to coat 150 mm×100 mm glass pieces with a six-layer anti-reflective stack where the annual production requirement is many millions of pieces, coating chambers can be designed to accommodate carriers that hold many individual pieces. For example, assuming 150 mm×100 mm pieces, a carrier 1.5 meters high by 1.8 meters long may be capable of holding approximately 150 of the pieces. An in-line system can be configured with several AC ion sources to deposit both the anti-reflective stack layers and the protective layer. For example, such a system can include six AC ion sources individually configured to deposit a different layer of an anti-reflective stack. Directly downstream from these six AC ion sources, the system can include another six AC ion sources all used to deposit the protective layer. The use of a greater number of AC ion sources for depositing the protective layer than for depositing the stack layers can be useful due to the relatively slow deposition rate of diamond-like carbon together with a relatively high carrier transport speed through the system. The respective deposition zones for the AC ion sources can span the width of the carrier such that all of the pieces are uniformly coated. The carrier can be moved past the AC ion sources at a constant speed. The process settings of each AC ion source can be adjusted so the layer thickness and film properties are correct for the constant speed shared by all the layers. Other reactor configurations are also possible, such as roll-to-roll batch configurations, large single-sheet configurations, and rotating-drum configurations.

### EXPERIMENTAL EXAMPLES

The following experimental examples are provided to illustrate certain particular features present in at least some embodiments of the present technology. It should be understood that additional embodiments, not limited to these particular features described, are consistent with the following experimental examples.

### Example 1

In this example, a borosilicate glass substrate was coated on each of its major sides with a scratch-resistant and anti-reflective film in accordance with an embodiment of the present technology. The film was formed using a single-ended, plasma enhanced chemical vapor deposition (PECVD) apparatus (General Plasma, Inc. of Tucson, Ariz., USA) configured to deposit one layer of the film at a time. The PECVD apparatus included a process chamber having a single alternating-current ion source (ACIS) and a conveyor configured to carry a substrate linearly past the ACIS. Silane was used as a first precursor gas and either ammonia (to form Si₃N₄) or oxygen (to form SiO₂) was used as a reactant gas to form a six-layer anti-reflective stack. The PECVD apparatus was then used to deposit a layer of diamond-like carbon on the anti-reflective stack. Process parameters, including precursor flow rates, power settings for the ACIS, and speed settings for the conveyor, were determined for each of the desired layers to develop a repeatable recipe.

The substrate (length 600 mm, width 300 mm, thickness 0.6 mm, refractive index 1.515) was first secured to a carrier and then loaded into the PECVD apparatus. After the process chamber reached a base pressure, ammonia gas was delivered to a deposition zone within the process chamber, a power supply to the ACIS was activated, and silane gas was delivered to the deposition zone. The substrate was conveyed past the ACIS and a first layer (Si₃N₄) of the anti-reflective stack was deposited. After the substrate passed the ACIS, the silane gas flow was stopped, the power supply was deactivated, and the ammonia gas flow was stopped. To deposit the second layer of the anti-reflective stack, oxygen gas was delivered to the deposition zone, the power supply was reactivated, and silane gas was again delivered to the deposition zone. The substrate was again conveyed past the ACIS and the second layer (SiO₂) of the anti-reflective stack was deposited. After the substrate passed the ACIS, the silane gas flow was stopped, the power supply was deactivated, and the oxygen gas flow was stopped. The process for depositing the first and second layers of the anti-reflective stack was repeated once to form third and fourth layers of the anti-reflective stack and then once more to form fifth and sixth layers of the anti-reflective stack.

Forming the protective layer included delivering argon and hydrogen gas to the deposition zone, activating a power supply to the ACIS, and delivering acetylene gas to the deposition zone. The substrate was conveyed past the ACIS and a first layer of diamond-like carbon was deposited. After the substrate passed the ACIS, the carrier direction was reversed and a second layer of diamond-like carbon was deposited. This was repeated two more times so that a total of six passes were made through the deposition zone. After the sixth pass, the acetylene gas flow was stopped, the power supply was deactivated, and the argon and hydrogen gas flows were stopped.

No metrology was performed inside the process chamber. After the film was formed, the thicknesses and refractive indexes of the individual layers were measured using a Filmetric F20 spectrophotometer and a Metricone 2010/M Prism coupler, respectively. Measured parameters (assuming an incident angle of 0° and a reference wavelength of 632 nm) for each of the six layers are listed in Table 1.

TABLE 1
Parameters of Layers of Example 1 Anti-Reflective Coating

| | | | | Optical | Physical |
|---|---|---|---|---|---|
| | | Ref. | Extinction | Thickness | Thickness |
| Layer | Material | Index | Coefficient | (FWOT) | (nm) |
| First | Si₃N₄ | 1.92822 | 0.00010 | 0.04029736 | 13.21 |
| Second | SiO₂ | 1.46500 | 0.00000 | 0.09695986 | 41.83 |
| Third | Si₃N₄ | 1.92822 | 0.00010 | 0.14908307 | 48.86 |
| Fourth | SiO₂ | 1.46500 | 0.00000 | 0.03178396 | 13.71 |
| Fifth | Si₃N₄ | 1.92822 | 0.00010 | 0.20762333 | 68.05 |
| Sixth | SiO₂ | 1.46500 | 0.00000 | 0.20310874 | 87.62 |
| Protective | DLC | 1.96000 | 0.00000 | 0.00682278 | 2.20 |

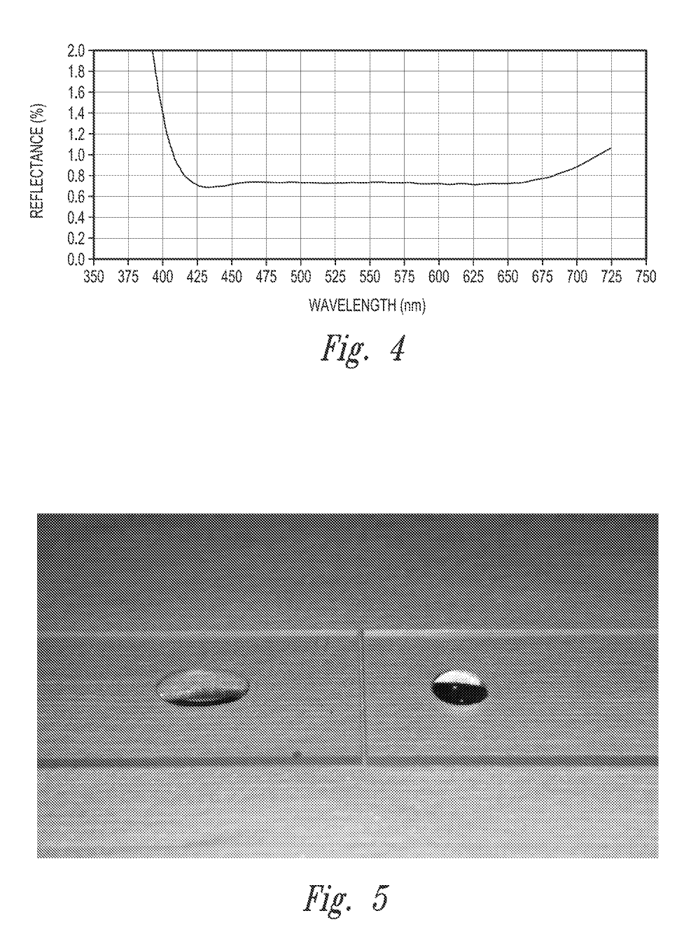

FIG. 4 is a graph of reflectance at different wavelengths for the coated substrate. As shown in FIG. 4, the reflectance was well under 0.8% over the visible spectrum.

### Example 2

In this example, the hydrophobicity and scratch resistance of a film with a diamond-like carbon protective layer relative to a corresponding film without a diamond-like carbon protective layer is demonstrated. In FIG. 5, the coated substrate on the left has a six-layer chemically deposited anti-reflective stack with Si₃N₄ high-refractive-index stack layers and no diamond-like carbon protective layer. The coated substrate on the right has a six-layer chemically deposited anti-reflective stack with Si₃N₄ high-refractive-index stack layers with a diamond-like carbon protective layer. As shown in FIG. 5 a water drop applied to the coated substrate on the left expanded outward, whereas a water drop applied to the coated substrate on the right retained a droplet shape. The film with a diamond-like carbon protective layer was therefore found to be more hydrophobic than the film without a diamond-like carbon protective layer. Hydrophobicity enhances a substrate's resistance to smudges and fingerprints, among other benefits.

To determine scratch resistance, an Erichsen pencil hardness test was employed. The Erichsen test pencil model 318S (Erichsen GmbH & Co. of Germany) was used with a tungsten carbide sphere chip and a stylus point diameter of 0.75 mm. The test procedure included: (1) setting spring force with a slider, (2) holding the instrument upright and placing its point on the test surface, and (3) making a 5 to 10 mm long line at a rate of approximately 10 mm/sec. Successive passes were made, increasing the spring force until a scratch just visible to the naked eye appeared in the test surface. The applied force when the scratch appeared was the recorded pencil hardness value for the test surface. Using this procedure, a six-layer chemically deposited anti-reflective stack with Si₃N₄ high-refractive-index stack layers and no protective layer of diamond-like carbon was found to have a pencil hardness of 1 Newton. In contrast, the same anti-reflective stack with a protective layer of diamond-like carbon was found to have a pencil hardness of 4 Newtons.

### CONCLUSION

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. Accordingly, this disclosure and associated technology can encompass other embodiments not expressly shown or described herein. In some cases, well-known structures and functions have not been shown or described in detail to avoid unnecessarily obscuring the description of embodiments of the present technology. Although steps of methods may be presented herein in a particular order, in alternative embodiments, the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments can also exhibit such advantages, and not all embodiments need necessarily exhibit such advantages or other advantages disclosed herein to fall within the scope of the present technology.

The methods disclosed herein include and encompass, in addition to methods of making and using the disclosed structures, methods of instructing others to make and use the disclosed structures. For example, a method in accordance with a particular embodiment includes forming an anti-reflective stack and disposing a diamond-like carbon protective layer over the anti-reflective stack. A method in accordance with another embodiment includes instructing such a method.

It is to be understood that in instances where a range of values is stated herein, the range is intended to encompass not only the end point values of the range but also intermediate values of the range as explicitly being included within the range and varying by the last significant figure of the range. By way of example, a recited range from 1 to 4 is intended to include 1-2, 1-3, 2-4, 3-4, and 1-4.

As used herein, “optical thickness” is defined as the physical thickness of a layer multiplied by the refractive index (RI) of that layer at a wavelength of 632 nm. The visible spectrum is generally accepted, and defined herein, as being light within a wavelength range from 425 nm to 675 nm. Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation unless the context clearly indicates otherwise. Similarly, the terms “on,” “over,” “under,” and the like do not denote absolute orientation nor do these terms preclude the presence of intervening structures unless the context clearly indicates otherwise.

Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

1. A scratch-resistant anti-reflective film, comprising:
an anti-reflective stack including successively stacked first, second, third, fourth, fifth, and sixth stack layers of alternating higher and lower refractive indexes; and
a protective layer overlying the anti-reflective stack, the protective layer being at least primarily composed of diamond-like carbon and having a thickness of not more than 5 nm,
wherein—
at least a 15 cm² region of the film is continuous,
average reflectance off the film at the region from normal incident light of wavelengths from 425 nm to 675 nm is not more than 1%,
average a* and b* in CIELAB color space for reflectance off the film at the region from −45° to 45° incident light of wavelengths from 425 nm to 675 nm are within a range from −2.0 to 2.0, and
the film has an average nanoindentation hardness at the region of at least 8 GPa using the Continuous Stiffness Measurement Technique.

2. The film of claim 1 wherein photopic absorption by the film at the region is less than 1% over the visible spectrum.

3. The film of claim 1 wherein the first through sixth stack layers are chemically deposited.

4. The film of claim 1 wherein the protective layer is chemically deposited.

5. The film of claim 1 wherein the thickness of the protective layer is not more than 4 nm.

6. The film of claim 1 wherein the thickness of the protective layer is not more than 3 nm.

7. The film of claim 1 wherein the thickness of the protective layer is within a range from 1 to 3 nm.

8. The film of claim 1 wherein the film has an optical thickness variation at the region of not more than 3% over a maximum dimension of the region.

9. The film of claim 1 wherein the protective layer directly overlies the anti-reflective stack.

10. The film of claim 1 wherein the anti-reflective stack has not more than six stack layers.

11. The film of claim 1 wherein the anti-reflective stack has not more than eight stack layers.

12. The film of claim 1 wherein the first, third, and fifth stack layers include a nitride.

13. The film of claim 1 wherein the first, third, and fifth stack layers include Si₃N₄.

14. The film of claim 1 wherein the first, third, and fifth stack layers have respective refractive indexes within a range from 1.66 to 2.39 at a wavelength of 632 nm.

15. The film of claim 1 wherein the second, fourth, and sixth stack layers include an oxide.

16. The film of claim 1 wherein the second, fourth, and sixth stack layers include SiO₂.

17. The film of claim 1 wherein the second, fourth, and sixth stack layers have respective refractive indexes within a range from 1.40 to 1.52 at a wavelength of 632 nm.

18. A composition, comprising:
a substrate having a major surface; and
a scratch-resistant anti-reflective film disposed along the major surface of the substrate,
wherein—
the film comprises—
an anti-reflective stack including successively stacked first, second, third, fourth, fifth, and sixth stack layers of alternating higher and lower refractive indexes; and
a protective layer overlying the anti-reflective stack, the protective layer being at least primarily composed of diamond-like carbon and having a thickness of not more than 5 nm,
at least a 15 cm² region of the film is continuous,
average reflectance off the film at the region from normal incident light of wavelengths from 425 nm to 675 nm is not more than 1%,
average a* and b* in CIELAB color space for reflectance off the film at the region from −45 to 45 incident light of wavelengths from 425 nm to 675 nm are within a range from −2.0 to 2.0, and
the film has an average nanoindentation hardness at the region of at least 8 GPa using the Continuous Stiffness Measurement Technique.

19. The composition of claim 18 wherein the film is formed in situ on the major surface of the substrate.

20. The composition of claim 18 wherein the substrate is rectilinear.

21. The composition of claim 18 wherein the substrate has rounded corners.

22. The composition of claim 18 wherein the substrate is flexible.

23. The composition of claim 18 wherein the substrate has at least one dimension larger than 150 mm.

24. The composition of claim 18 wherein the protective layer is an outermost layer of the film relative to the substrate.

25. The composition of claim 18 wherein the substrate is at least substantially transparent to light at wavelengths from 425 nm to 675 nm.

26. An electronic device, comprising:
a housing;
display circuitry disposed within the housing, the display circuitry being operable to generate an electronic display;
a display window overlying the display circuitry, the display window having a first major surface positioned closer to the display circuitry and an opposite second major surface positioned further from the display circuitry; and
a scratch-resistant anti-reflective film disposed along the second major surface of the display window,
wherein—
the film comprises—
an anti-reflective stack including successively stacked first, second, third, fourth, fifth, and sixth stack layers of alternating higher and lower refractive indexes; and
a protective layer overlying the anti-reflective stack, the protective layer being at least primarily composed of diamond-like carbon and having a thickness of not more than 5 nm,
at least a 15 cm² region of the film is continuous;
average reflectance off the film at the region from normal incident light of wavelengths from 425 nm to 675 nm is not more than 1%,
average a* and b* in CIELAB color space for reflectance off the film at the region from −45 to 45 incident light of wavelengths from 425 nm to 675 nm are within a range from −2.0 to 2.0, and
the film has an average nanoindentation hardness at the region of at least 8 GPa using the Continuous Stiffness Measurement Technique, and
the electronic display is viewable via the film and the display window.

27. The electronic device of claim 26 wherein the device is a mobile phone.

28. The electronic device of claim 26 wherein the device is a tablet computer.

29. The electronic device of claim 26 wherein the display circuitry is touch operated.

30-40. (canceled)
